(19) United States
(12) Patent Application Publication
(10) Pub. No.: US 2009/0324667 A1
(43) Pub. Date: Dec. 31, 2009

(54) USE OF FUNGAL INOCULA FOR THE IMPROVEMENT OF MARKET GARDENING PRODUCTION

(75) Inventors: Robin Duponnois, Mercurey (FR); Michel Lepage, Larchant (FR)

Correspondence Address: YOUNG & THOMPSON, 209 Madison Street, Suite 500, Alexandria, VA, 22314, US

(73) Assignee: Institut De Recherche Pour Le Developpement (I.R.D.), Paris Cedex 10 (FR)

(21) Appl. No.: 12/374,845

(22) PCT Filed: May 16, 2007
(86) PCT No.: PCT/FR2007/000829

§ 371 Date: Apr. 28, 2009

(30) Foreign Application Priority Data
Jul. 25, 2006 (FR) 0606793

(51) Int. Cl. A01N 25/12; A01M 1/20; A01N 63/00; A01N 25/08; A01P 5/00

(52) U.S. Cl. 424/409; 43/132.1

(57) ABSTRACT

The present invention relates to a novel use of termites' nest powder, as an agent for controlling phytoparasitic nematodes for improving crops, in particular cereal, fodder, market garden, fruit or horticultural crops, and to the method for obtaining same.

This invention relates to the use of fungal inocula for the improvement of market gardening production.

Nematodes are vermiform animals which are made of an outer tube (cuticle) wrapping two superimposed inner tubes: the digestive tract with a stylet and the genital tract (male or female).

Phytoparasitic nematodes belong to two orders: the Dorylaimida and the Tylenchida, among which several different species may be distinguished: root nematodes (Tylenchus, Pratylenchus), gall nematodes (Meloidogyne . . .), and aerial parts nematodes (Ditylenchus, Aphelenchoides)

Gall nematodes belonging to the genus Meloidogyne are very dangerous pests which attack a wide variety of crops, notably garden crops (Sikora, R. A (2005). Nematode parasites of vegetables; in: Luc, M., Sikora, R. A., Bridje, J. (Eds.). Plant-Parasitic nematodes in Subtropical and Tropical Agriculture. 2^{nd} Edition. CABI Publishing, Wallington, UK, pp. 319-392).

They breed by laying eggs and, when the egg appears, the larva moves in the water film above the earth particles and toward the young roots of crops. It perforates the cell wall with its stylet, penetrates into the root, moves towards conductor ducts and induces the development of giant cells which are necessary for its growth. The result is the appearance of a characteristic gall which soon wraps it completely and clogs the sap conducting ducts. After several moultings, the larva turns male or female. The male is liberated outside the root. The female, which is motionless, remains in the tissues and lays between 1,000-2,000 eggs which are embedded in a gelatinous mass which maintains them together and which soars above the surface of the eggs. Several generations may follow one another under favourable conditions, and infestation may then reach very high levels.

On the other hand not all eggs hatch at the same time, some only hatch several months after laying and resist cold and dryness. Therefore the grounds still remains infectious during the winter or during dormancy.

Thus damage caused by nematodes has made it necessary to develop specific means for the control of these pathogens.

Traditionally control methods were based on the spreading of chemical products onto the ground, for instance 1,2-dibromo-3-chloropropane (DBCP) or methyl bromide, a costly process which is very toxic for the environment and for the operators. When production of some of them had to be stopped, notably methyl bromide, (Hutchinson, C. M. et al., Nematology, 1999, 1: 407-414; Nico, A. I. et al., Crop Protection, 2004 23: 581-587), other means of pest control had to be identified, for instance a combination of 1,3-dichloropropene and chloropicrine (Giannakou, I. O. et al., Crop Protection, 2005; 24: 499-506; Gilreath, J. P. et al., Crop Protection, 2005; 24: 903-908.), (ii) the optimization so-called physical control measures (solarization, flooding of the ground . . . ) and (iii) the search for microbial antagonists as present in the ground (parasite fungi of nematode eggs, bacteriae) (Siddiqui, I. A. Soil Biology and Biochemistry, 2003; 35: 1359-1368)

French patent Fr 2 747 016 describes the use of compositions comprising new strains of fungi with their associated bacteriae (Bacillus licheniforme, Pseudomonas vesicularis) for the biological control of nematodes.

Patent application WO 0 152 655 describes the use of compositions comprising chitin as produced from crustacean shell scraps, and one or more Actinomycetes spp. chosen among ground populations for their activity against pathogenic agents.

In the same manner, the document (Jonathan et Al, Nematropica (USA), 2000, 30, (2), p. 231-240) describes the use in greenhouses of rhizobacteriae which foster plant growth (notably Pseudomonas fluorescens), of unspecified Actinomycetes and Pasteuria penetrans on tomato and banana plants. All bacteriae and Actinomycetes fostered the growth of both species and inhibited the development of root galls on tomatoes, as well as the breeding of Meloidogyne incognita.

However each of these newly developed methods entails disadvantages.

Chemical nematocides are generally too expensive for farmers in most developing countries, and still remain comparatively toxic in use for operators.

Physical methods require specific equipments and/or a significant extra cost in labour, which cannot be contemplated in these parts of the world.

Finally, the use of phytoparasitic nematode antagonists is still in the experimental stage, and convincing and—above all—reproducible results under usual crop production conditions still remain too rare to be widespread among potential users (Backman, P. A. et al., Bacteria for biological control of plant diseases; in: Rechcigl, N. A., Rechcigl, J. E. (Eds.), Environmentally Safe Approaches to Crop Disease Control. CRC Lewis Publishers, Boca Raton, 1997, pp. 95-109)

Termite nests are structures built by various termite species as naturally present in some parts of Africa, notably Cubitermes sp. or Macrotermes sp.

Termite bowels contain Actinomycetes and Pseudomonas whose use, after having been isolated from the bowels, is known for the degradation of lignin or cellulose (M B Pasti et al. Appl Environ Microbiol. 1990; 56(7): 2213-2218; Watanabe Y et al. Biosci Biotechnol Biochem. 2003 August; 67(8):1797-801), or as a method for the decontamination of soils from various chemicals (phenol, cresol, furan, trichloroethylene).

The use of termite nest powder is also known in order to stimulate biological interactions in the ground, and to eliminate pathogenic agents such as Rhizoctonia spp. fungi (Lepage M et al., Sciences au Sud- Le Journal de l'IRD ; mai/juin 2006; N°35)

On the other hand, bacteriae as obtained from nematodes are known as agents for destroying termites (U.S. Pat. No. 7,037,494; US Application 2003/0 082 147), or again the use of nematodes alone or in association with a regulator or a slow release insecticide is known for destroying termites (Application WO 0 165 944; JP Patent 7 048 215)

One aim of the invention is to yield an agent for the control of nematodes without any inflow of chemical pesticide, for areas to be cultivated, notably for cereals, fodder or garden crops, fruit and horticultural crops.

Another aim of the invention is also to supply a composition of matter which makes it possible to obtain an inoculum for controlling phytoparasitic nematodes.

Another aspect of the invention relates to a method for controlling phytoparasitic nematodes in areas to be cultivated, notably for cereals, fodder or garden crops, fruit and horticultural crops.

The invention relates to the use of termite nest powder as an agent for the control of phytoparasitic nematodes.

The phrase <<agent for the control of>> in this context means a compound which is used in a curative manner for the degradation of nematode egg walls.

The term phytoparasitic nematodes means root nematodes (Tylenchus, Pratylenchus), gall nematodes (Meloidogyne . . .), aerial parts nematodes (Ditylenchus, Aphelenchoides).

The four commonest gall nematodes belonging to the genus Meloidogyne are M. arenaria, M. incognita, M. javanica, M. hapla.

The termite nest powder as used here shows moreover additional benefits in that it is naturally available in large quantities, at a very low cost, it is compatible with socioeconomic conditions of rural populations of Africa, it allows one to obtain better quality and cheaper products, and thus to fight desertification and increase producer income in arid and semi-arid areas of West Africa.

The invention more particularly relates to the use of termite nest powder from termites belonging to the genus Cubitermes or Macrotermes.

These two genera are frequently observed in the Sahelian and Sudan-Sahelian regions, and they take an important part in the workings of the soil.

According to an advantageous embodiment the invention relates to the use of termite nest powder in association with a substrate in order to make up an inoculum.

The term substrate here means all types of composts obtained from crop residues.

The preferred substrate is garden mould, which may be mixed with some sand.

According to another embodiment the invention relates to the use of an amount of termite nest powder, in relation to the substrate, which is below 10% (m:v) and advantageously between 1% (m:v) and 10% (m:v), and preferentially from 1% (m:v) to 5% (m:v), and which is more preferably 1%.

The use of 10% termite nest powder, as mixed with the substrate, has made it possible, during an experiment in the field, to increase the number of tomatoes produced, for each seedling, from 187 to 669% in relation to plants which were grown with naked roots, and from 157 to 321% in relation to plants which were grown in garden mould.

The use of an amount of termite nest powder above 10% in relation to the substrate cannot be considered because this would represent too large an amount of termite nest powder.

According to an advantageous embodiment the invention relates to the use as here above defined, in areas to be cultivated, notably for cereals, fodder or garden crops, fruit and horticultural crops.

The term <<areas to be cultivated>> means here every type of container with appropriate elements for cultivation, such as pots, trays, jars, seed trays, this being non limitative, as well as any type of ground, land plot, field, greenhouse, &c.
Cereal crops notably include barley, oats and wheat.
Fodder crops include leguminous plants such as clover, alfalfa and bird's foot trefoil, and various gramineae, such as common timothy and cock's foot.
Garden crops notably include tomatoes, eggplants, potatoes, carrots, lettuce, cucumber, melon, cabbage, and cauliflower, this being non limitative.
Fruit crops notably include apples, pears, grapes, cherries, and plums, this being non limitative.
Horticultural crops notably include flowers and ornamental plants, this being non limitative.

The invention also relates to a composition of matter comprising:
a. termite nest powder, the particle size within said powder being between 1 μm-1,000 μm and preferentially between 1 μm-500 μm
b. said substrate being chosen among compost from crop residues, preferentially garden mould, which may be mixed with sand, the garden mould: sand ratio being advantageously (1:1) (v:v),
   the termite nest powder: substrate ratio being below 10% and advantageously between 1% (m:v)-10% (m:v), preferentially between 1% (m:v)-5% (m:v), and more preferentially being 1% (m:v).

Structures from termite nests are first minced, then comminuted. This crushed mass is then sieved with a 500 μm mesh size sieve.

This sieve allows one to eliminate gross particles from the structure of termite nests (stone type).
Generally over 95% (volume) of the termite nest may be minced and comminuted.
If the obtained powder is not comminuted, the particles are too gross and the structure of termite nests may not be homogeneously distributed within the substrate.

The use of 10% termite nest powder, as mixed with the substrate, has made it possible, during an experiment in a rural area, to notably increase production of the number of tomatoes for each plant, by 187-669% in relation to plants which are raised with naked roots, and by 157-321% in relation to plants which are raised in garden mould.

According to another advantageous embodiment the termite nest powder as used in the above-mentioned composition is obtained from termites belonging to the genus Cubitermes or Macrotermes.

The invention also relates to a method for controlling phytoparasitic nematodes in areas which are to be cultivated, notably for cereals, fodder or garden crops, fruit or horticultural crops, wherein an inoculum has been introduced, the inoculum having been prepared by mixing termite nest powder with a substrate, said powder, if need be, being then comminuted.

This method has made it possible, in an experiment in a rural area, to increase in a notable manner the production in numbers of tomato plants for each plant, viz. from 187% to 669% in relation to plants which have been raised with naked roots without any termite nest powder, and from 157% to 321% in relation to plants which have been raised in garden mould without termite nest powder.
According to an advantageous embodiment of the above-described method the particle size of said termites powder is between 1 μm-1,000 μm (particle size should be more precisely determined), and preferentially between 1 μm-500 μm.

According to another advantageous embodiment of the above-described method, the termite nest powder is obtained from termites belonging to the genus Cubitermes or Macrotermes.

According to yet another embodiment of the above-described method, the inoculum is prepared by mixing said termite nest powder with a substrate, said substrate being chosen from among the compost as obtained from cultivation residues, preferentially garden mould, mixed, if need be, with sand which, the garden mould: sand ratio being advantageously (1:1) (v:v), the termite nest powder: substrate ratio being from 1% (m:v) to 10% (m:v), preferentially from 1% (m:v) to 5% (m:v) and being more preferentially 1% (m:v).

In a preferred embodiment of the above-described method, the inoculum is introduced in areas to be cultivated at doses between 1-25 ml inoculum for each cultivation unit element, preferentially between 1-10 ml inoculum, and more preferentially at a dose of 1 ml inoculum, said cultivation unit element being notably a seed or a plant.

The term <<cultivation unit element>> means a seed, grain, fruit, pip, stone or plant allowing one to obtain a cereal, fodder, garden, fruit or horticultural crop.

According to an advantageous embodiment of the above-described method a grain is seeded or a plant is transferred for each dose of inoculum which is introduced into areas to be cultivated.

The inoculum is introduced at a dose between 1-25 ml in areas to be cultivated, then a grain is seeded or a plant is transferred into that inoculum. The amount of termite nest powder for each plant, as contained in that inoculum, is between 0.01 g-2.5 g.

According to another advantageous embodiment, the method for controlling phytoparasitic nematodes as hereabove described includes the following steps:
a. collection and, if need be, mincing of termite nest powder, wherein the particle size of said powder is between 1 μm-1,000 μm and preferentially between 1 μm-500 μm,
b. preparation of an inoculum by mixing said powder with a substrate, said substrate being chosen from among compost obtained from cultivation residues, preferentially garden mould, which is, if need be, mixed with sand, the garden mould: sand ratio being advantageously (1:1) (v:v), the termite nest powder: substrate ratio being between 1% (m:v)-10% (m:v), preferentially between 1% (m:v)-5% (m:v), and more preferentially 1% (m:v),
c. introduction of the inoculum into areas to be cultivated at doses between said limits.
d. sowing of a grain or transfer of a plant into areas for cultivating crops containing the inoculum.

### Experimental Part

### EXAMPLE 1

### Preparation of Plants

Flats filled with a previously sterilized (140° C., 40 min) sandy soil are placed under a shade shelter. Tomato and eggplant seeds are sown and watered without fertilizers added. After 15 days' cultivation the plantlets are transplanted into plastic plug flats.

### EXAMPLE 2

### Preparation of the Termite Nest Powder Inoculum

The termite nest biogenic structures are harvested in their natural environment, brought back to the laboratory and reduced in powder form, then sieved on a 500 μm sieve.

### EXAMPLE 3

### Preparation of Mini Sowing Bricks

Polyethylene seed trays are used as cultivation supports (96 plugs may each contain a substrate volume of 25 ml).

Garden mould, as purchased on the market, is used as a culture substrate.

This garden mould is mixed with various doses of termite nest powder, belonging to the genera Cubitermes and Macrotermes (10%, 5%, 1%, 0% (control); m:v).

The plugs of plastic plug flats are filled with these various mixtures, and a plant is transferred into each plug.

Once thus prepared the flats are placed under a shade shelter during two weeks before transplantation in the field.

The plugs of the thus filled flats form mini sowing bricks.

### EXAMPLE 4

### Preparation of Phytoparasitic Nematodes Belonging to the Genus Meloidogyne

Juvenile organisms obtained from egg masses belonging to the Meloidogyne (gall nematode) species which are the most frequently observed in West Africa (M. incognita, M. arenaria, M. javanica et M. mayaguensis) are inoculated to eggplants which were cultivated in previously sterilized soil (140° C., 40 min). After 2 months' cultivation the plants are taken out of the pots and the nematodes are collected according to the Seinhorst method (Seinhorst, J. W., Modifications of the elutriation method for extracting nematodes from soils. Nematologica, 1962; 8: 117-128.

### EXAMPLE 5

### Evaluation of the Various Cultivation Conditions

1. Greenhouse Experiment in a Controlled Medium
Plants as cultivated in mini sowing bricks which are (or are not) improved with termite nest powder are transferred into pots filled with a previously sterilized soil. This cultivation technique is compared with that which is usually adopted by farmers in these areas, viz. a transfer of plants with naked roots using young seedlings of the same age but raised in flats filled with sterilized sand (140°, 40 min).
After a week's growth in a greenhouse under controlled conditions, the soil from pots in <<naked roots>> and <<mini sowing bricks without termite nest powder improvement>> treatments is treated with a nematicide (Aldicarb, Rhô ne-Poulenc Ag. Co. following doses as prescribed by the manufacturer.
Following this, second stage juvenile organisms (J2) from each species of Meloidogyne are inoculated (or not, for controls without nematodes) at a rate of 100 and 500 J2 per pot. This experimental device allows one to
   (i) reveal the impact of the mini sowing brick on the proliferation of phytoparasitic nematodes and
   (ii) evaluate the action of termite nest powder against these nematodes in relation to that of the nematicide which is used.
The term <<naked roots>> means that the plants are transferred without mini sowing bricks or any other additive around the roots.
The term <<mini sowing bricks which are (or are not) improved >> means here that termite nest powder is, or is not, added to the mini sowing bricks.

2. Field Experiments
The experiments are installed at the beginning of the rainy season. For each flat, the various treatments which are carried out are the following:
   (1) Naked roots;
   (2) Sowing in mini sowing bricks;
   (3) Sowing in mini sowing bricks whose substrate has been improved with termite nest powder at various doses.
For land plots in treatments (1) and (2), the soil for cultivation is treated, or not treated, with the nematicide Aldicarb at the dose which is recommended by the manufacturer.

3. Measurement of Growth Parameters
In the greenhouse experiment, after cultivation during two months, the plants are taken out of the pots and their growth is measured (height, aerial and root biomasses) as well as their degree of infestation by each species of Meloidogyne.
In the field experiment, the parameters which are retained for measuring the effect of the various treatments are the following:
H: Height (cm),
Fl.: Number of flowers,
Fr.: Number of fruits,
Ra.: Number of branchings which are measured each month.
Roots are collected each month in order to assess the infestation rates of tomato and eggplant by Meloidogyne populations as naturally present in these garden cultivation areas.

This method, at a dose of 10% termite nest powder, as mixed with the substrate, has allowed, during an experiment in a rural area, to notably increase production in numbers of tomatoes per plant, from 187 to 669% in relation to plants as raised with naked roots, and from 157 to 321% in relation to plants as raised in garden mould.

Various experiments carried out in a greenhouse have made it possible to show that termite nest powder was effective on plant development at a dose of 5 and 1% (v:v).

1-14. (canceled)

15. A method for controlling phytoparasitic nematodes comprising the use of termite nest powder.

16. The method according to claim 15, wherein the termite nest powder is obtained from termites belonging to the genus Cubitermes or Macrotermes.

17. The method according to claim 16, wherein the termite nest powder is associated with a substrate in order to make up an inoculum.

18. The method according to claim 15, wherein the amount of termite nest powder in relation to the substrate is below 10% (m:v) and advantageously between 1% (m:v)-10% (m:v), preferentially between 1% (m:v)-5% (m:v), and more preferentially 1%.

19. The method according to claim 15, notably in areas for the cultivation of cereal, fodder, garden, fruit or horticultural crops.

20. A composition of matter comprising:
a. termite nest powder, wherein the particle size in said powder is between 1 μm-1,000 μm and preferentially between 1 μm-500 μm
b. said substrate is chosen from among garden mould from cultivation residues, preferentially garden mould, which, if need be, may be mixed with sand, the garden mould: sand ratio being advantageously (1:1) (v:v), the termite nest powder: substrate ratio being below 10% and advantageously between 1% (m:v)-10% (m:v), preferentially between 1% (m:v)-5% (m:v) and more preferentially being 1% (m:v).

21. The composition of matter according to claim 20, wherein the termite nest powder is obtained from termites belonging to the genus Cubitermes or Macrotermes.

22. A method for the control of phytoparasitic nematodes in areas to be cultivated, notably for cereal, fodder, garden, fruit or horticultural crops, wherein an inoculum has been introduced, the inoculum having been prepared by mixing termite nest powder with a substrate, said powder being, if need be, later comminuted.

23. The method according to claim 22, wherein the particle size of said termite nest powder is between 1 μm-1,000 μm (particle size should be more precisely determined) and preferentially between 1 μm-500 μm.

24. The method according to claim 22, wherein the termite nest powder is obtained from termites belonging to the genus Cubitermes or Macrotermes.

25. The method according to claims 22, wherein the inoculum is prepared by mixing said termite nest powder with a substrate, said substrate being chosen from among compost obtained from cultivation residues, preferentially garden mould, which, if need be, is mixed with sand, the garden mould: sand ratio being advantageously (1:1) (v:v), the termite nest powder: substrate ratio being between 1% (m:v)-10% (m:v), preferentially between 1% (m:v)-5% (m:v), and more preferentially being 1% (m:v).

26. The method according to claim 22, wherein the inoculum is introduced in areas for cultivation at doses between 1-25 ml inoculum for each cultivation unit element, preferentially between 1-10 ml inoculum, and more preferentially at a dose of 1 ml inoculum, said cultivation unit element being notably a grain or a plant.

27. The method according to claim 22, wherein a grain is sown or a plant is transferred for each dose of inoculum which is introduced in areas for cultivation.

28. The method for the control of phytoparasitic nematodes according to claim 22 comprising the following steps:
a. collection and, if need be, comminuting of termite nest powder, wherein the particle size of said powder is between 1 μm-1,000 μm and preferentially between 1 μm-500 μm),
b. preparation of an inoculum by mixing said powder with a substrate, said substrate being chosen from among compost obtained from cultivation residues, preferentially from garden mould, which, if need be, is mixed with sand, the garden mould: sand ratio being advantageously (1:1) (v:v), the termite nest powder: substrate ratio being between 1 % (m:v)-10% (m:v), preferentially between 1% (m:v)-5% (m:v) and more preferentially being 1% (m:v),
c. introduction of the inoculum into areas to be cultivated at doses between 1-25 ml inoculum for each cultivation unit element, preferentially between 1-10 ml inoculum for each cultivation unit element, and more preferentially at a dose of 1 ml inoculum for each cultivation unit element,
d. sowing of a grain or transfer of a plant into areas to be cultivated with crops containing the inoculum.

29. The method according to claim 23, wherein the termite nest powder is obtained from termites belonging to the genus Cubitermes or Macrotermes.
